(19) United States
(12) Patent Application Publication
(10) Pub. No.: US 2006/0272943 A1
(43) Pub. Date: Dec. 7, 2006

(54) A versatile electrochemical sensor for sensing fuel concentration in an aqueous solution

(75) Inventors: Chun Ching Chien, Long Tang, Taoyuan (TW); King Tsai Jeng, Long Tang, Taoyuan (TW); Shean Du Chiou, Long Tang, Taoyuan (TW); Su Hsine Lin, Long Tang, Taoyuan (TW); Wan Min Huang, Long Tang, Taoyuan (TW); Sheng Shieh Chen, Long Tang, Taoyuan (TW)

Correspondence Address: MICHAEL LIN, 5F 79 Roosevelt Rd. Sec. 2, TAIPEI, 106, TW

(73) Assignee: INSTITUTE OF NUCLEAR ENERGY RESEARCH, Long Tang, Taoyuan (TW)

(21) Appl. No.: 10/908,990

(22) Filed: Jun. 3, 2005

(51) Int. Cl. G01N 27/26

(52) U.S. Cl. 204/415

(57) ABSTRACT

A simple fuel cell-type electrochemical sensor for sensing the concentration of a specific fuel, e.g., methanol, ethanol, formic acid, sodium borohydride, etc., prepared in an aqueous solution is developed. The sensor is mainly composed of a membrane electrode assembly (MEA), which is made by hot pressing a piece of electro catalytic anode and a piece of electro catalytic cathode on each side of a proton exchange membrane (PEM), such as Nafion® 117. It is uniquely designed to have an anode size much smaller than that of the cathode and utilizes ambient air as an oxidant. The innovative approach is to ensure the fuel diffused to the anode/membrane interface can be totally reacted so as to eliminate the interferences of fuel crossover and enhance output signal. Thus, the measured sensor current reflects the concentration of diffusion-limited fuel at the membrane/electrode interface, which is proportional to fuel concentration in the bulk. It can be easily operated in a passive mode as well as in an active mode with aqueous fuel solution under a stagnant or a flowing condition. The applications include uses in fuel cell systems, such as direct methanol fuel cell systems, for sensing and monitoring fuel concentration in an aqueous solution.

### FIELD OF THE INVENTION

This invention relates to an electrochemical sensor for measuring the concentration of fuel, in particular methanol fuel, in an aqueous solution and for applications with fuel cell systems, such as direct methanol fuel cell (DMFC) systems, using fuels prepared in aqueous solutions. The novel approach involves the use of an asymmetric electrode pair structure to limit fuel diffusion and eliminate interferences of fuel crossover, as well as to ensure complete burning of fuel at anode/membrane interface via electrochemical reactions in both stagnant and flowing conditions. The sensor operates in a manner of a small DMFC, but a small depolarization voltage can also be applied to enhance the sensor output signal.

### BACKGROUND OF THE INVENTION

Membrane fuel cells, particularly direct methanol fuel cells (DMFCs), are regarded as potential mobile and stationary power sources due to high energy density, easy operation and simple fuel supply. However, DMFCs suffer from problems of methanol crossover particularly at high methanol concentrations. When methanol crossovers from the anodic side to the cathodic side, electro oxidation of methanol occurs giving rise to a mixed potential and lowering the cell voltage. In addition, more fuel is consumed in vain. Thus, low methanol concentration (e.g., 1 M) is employed in most DMFCs to eliminate or alleviate such drawbacks.

Unfortunately, low concentration of methanol requires a fuel container with large volume to store and is not desirable for any DMFC system design. To solve this problem, concentrated or pure methanol is used as the fuel source and diluted into lower concentrations suitable for current DMFC operating conditions. Therefore, a methanol sensor is indispensable in a complete DMFC system using high concentrations of methanol as fuel, and development of methanol sensors has become a subject of special interest.

There are several methods that can be used to measure methanol concentrations, including density measurement, refractometry, ultraviolet light absorptivity, etc. Due to practical application considerations, attempts have been focused on fabricating a methanol sensor that is simple in structure, accurate in sensing and easy in operation. In particular, stresses are focused on sensitivity and response time of the sensor. State-of-the-art methanol sensor is a fuel cell-type electrochemical sensor, i.e., the sensor itself is basically a small DMFC. However, such an electrochemical sensor has several designs and operation methods.

For example, Barton et al. in J. Electrochemical Soc., vol. 145, No. 11, pp. 3783-3788, November 1998, reported a methanol sensor in which the membrane electrode assembly (MEA) is exposed to the methanol solution on one side and the methanol flux across the membrane is electro-oxidized at other side of the MEA by applying a high DC voltage (about 1.0 V) across the two electrodes. For this type of sensor, the cathode is exposed to the methanol solution and the cathode reaction is hydrogen evolution. The anode reaction is electro oxidation of the methanol that crossovers the membrane. The use of a high applied DC voltage is apparent a drawback. In Electrochemical and Solid-State Letters, vol. 3, No. 3, pp. 117-120, March 2000, Narayanan et al. described a modification to such a design by circulating the methanol solution through both sides of the MEA and applying a lower voltage (0.45-0.65 V) to avoid dissolution of catalysts, particularly Pt—Ru. However, such a sensor is suggested to apply to only very low concentrations of methanol (<2 M).

Another fuel cell-type methanol sensor has been disclosed by Ren et al. in U.S. Pat. No. 6,488,837, in which the cathode is flow with air and the cathode is fed with methanol and operated in a passive mode, i.e., no external voltage was applied. In other words, the methanol sensor was functioning as a small DMFC. The advantage is a simple design without using additional power sources. However, oxygen or air feeding is still needed and such a design is also limited to low methanol concentrations.

More recently, in U.S. Pat. No. 6,527,943 Zhang et al. have described a fuel cell-based concentration sensor working by decreasing the load across the fuel cell terminals and by increasing the amount of oxidant supplied to the fuel cell. In this way, the sensor can avoid saturation when measuring methanol concentration from 0 M to over 4 M in liquid aqueous solution. The sensor was said to be suitable for a flowing system. Furthermore, in U.S. Pat. No. 6,836,123 Qi et al. disclosed a new sensing device design, which has a flexible composite of layered materials wrapped around a flexible tube having aperture contact with a methanol flow stream. The layered materials wrapped on the tube are, in fact, a set of MEA and current collectors. This is also a fuel cell-type concentration sensor to be used for a flowing system.

### SUMMARY OF THE INVENTION

In accordance with the present invention, a novel approach is employed to fabricate a novel fuel cell-type electrochemical sensor that uses air in the atmosphere as an oxidant to detect the concentration of fuel, which is prepared in a form of aqueous solution. FIG. 1 illustrates the fundamental structure of the new electrochemical sensor. The innovation is expanding the cathode exposed area while shrinking the anode exposed area so that there is sufficient oxygen supply to totally consume fuel that diffuses to anode/membrane interface. The advantage is that it can be operated in both passive and active modes. The former is basically a small DMFC and needs no external applied DC voltage to operate while the latter is converted to a small electrolyzer requiring only a small applied DC voltage (<0.3V) to operate. For both passive and active mode operations, the electrochemical reactions of methanol fuel can be expressed as:
Anode CH₃OH+H₂O→CO₂+6H⁺+6e⁻
Cathode 3/2O₂+6H⁺+6e⁻→3H₂O

This applied DC voltage has depolarization effects leading to enhancement of sensor electrochemical reactions and, in turn, sensor current signals. In addition, the sensor can be operated with fuel solution in a stagnant or a flowing condition. Thus, the structure of electrochemical fuel concentration sensor is simpler and the operation is more versatile. The electrochemical sensor is to be used for sensing a variety of fuel solutions in addition to commonly used methanol aqueous solution.

### BRIEF DESCRIPTION OF THE DRAWINGS

The accompanying drawings serve to explain the principles of the invention and illustrate the embodiments of the present invention. In the drawings:

FIG. 1 illustrates components and assembly of the electrochemical sensor including membrane electrode assembly (MEA) 1, anode 2, cathode 3, current collector 4, endplate 5, gasket 6, current collector drilled holes 7 & 8, cathode endplate opening 9, fuel solution reservoir 10, and fuel solution flow channel 11. The unique characteristics include having an asymmetric electrode structure and direct use of ambient air for cathode electro reduction.

FIG. 2 shows current vs. time (i-T) curves according to an exemplary embodiment (EXAMPLE 1) of the present invention. The two curves shown here are obtained at 20° C. using 1.0 M methanol fuel solution in which the 0.0V applied voltage is for a passive operation mode while 0.2V is for the active mode.

FIG. 3 shows current vs. time (i-T) curves according to an exemplary embodiment (EXAMPLE 2) of the present invention. The two curves shown here are obtained at 20° C. using 6.0 M formic acid aqueous solution in which the 0.0V applied voltage is for a passive operation mode while 0.2V is for the active mode.

FIG. 4 shows current vs. time (i-T) curves according to an exemplary embodiment (EXAMPLE 3) of the present invention. The curve shown here is obtained at 20° C. using 0.5 M sodium borohydride aqueous solution under an active mode.

FIG. 5 shows calibration curves for the electrochemical sensor according to an exemplary embodiment (EXAMPLE 4) of the present invention. The two curves shown here were obtained at 40° C. using a passive mode (0.0V) and an active mode (0.2V).

FIG. 6 illustrates current vs. temperature (i-T) relationship for the electrochemical sensor at a fixed methanol concentration according to an exemplary embodiment (EXAMPLE 5) of the present invention.

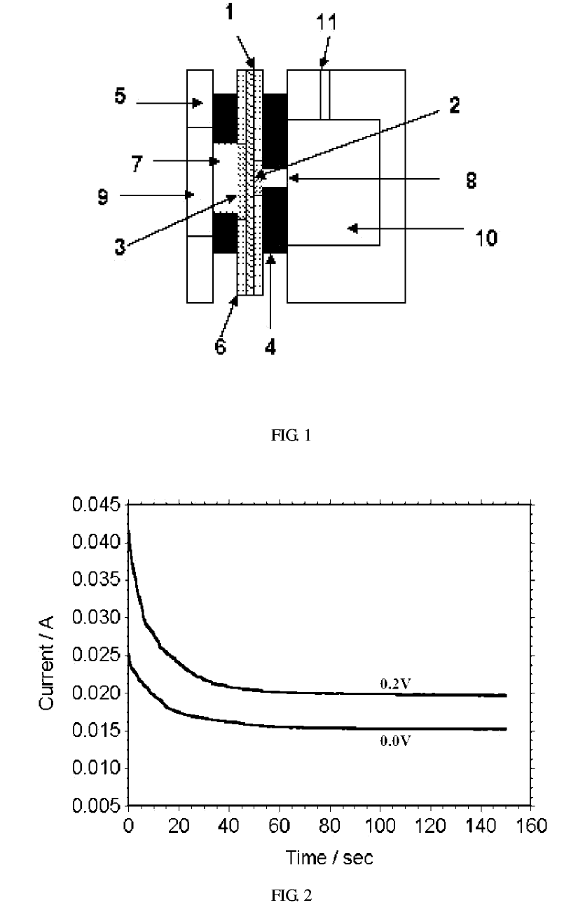

### DETAILED DESCRIPTION OF PREFERRED EMBODIMENTS

The heart of the electrochemical sensor, i.e., membrane electrolyte assembly (MEA) 1, is fabricated using a small piece of Nafion® 117 membrane hot pressed with a Pt/C coated cathode 3 and a Pt—Ru/C coated anode 2 on both sides. The catalyst loading for each electrode is 4 mg/cm² but the anode has a geometric area much smaller than that of the cathode. The MEA is assembled into a fuel cell-type electrochemical sensor using two pieces of graphite plate as the current collectors 4. A hole is drilled at the center of each graphite plate for the introduction of air and fuel solution to the respective electrode. The hole on the cathode side plate 7 has a dimension much larger than that on the anode side plate 8 making the exposed area ratio of anode/cathode of 1/4. This is to ensure that only a small amount of fuel is diffused to the anode/membrane interface and can be totally reacted in conjunction with oxygen reduction at the cathode. The end plates are two pieces of Plexiglas. The cathode end plate has a large hole 9 opening the cathode to air while the anode end plate had a small reservoir 10 coupled with two channels 11 for addition and removal or flowing of fuel solution.

For demonstration of the feasibility and capability of the invented electrochemical sensor, experiments are carried out in an oven by exposing the cathode to ambient atmosphere without real forced circulation of the air. Methanol and other fuels are prepared into aqueous solutions of various concentrations using analytical grade chemical and deionized water (resistivity>16.0 MΩ cm). The transient oxidation current of fuel at each specific concentration is measured using a potentiostat for a period of time until a steady state is reached. A corresponding calibration curve of steady state oxidation current versus methanol concentration is then constructed. The sensor is operated that when in a passive mode no external DC voltage is applied and when in an active mode a small external DC voltage, e.g., 0.2 V, is applied. The sensor is tested using methanol aqueous solutions under stagnant conditions, i.e., without the use of a circulation pump. This is equivalent to measuring the methanol concentration in a mixing tank instead of in the flow channel as commonly used. Therefore, more accurate results are expected. However, it can also be operated with fuel solution in a flowing condition.

### Example 1

This embodiment serves to illustrate the principle of the electrochemical sensor in signal sensing by measurement the electro oxidation current of diffused methanol. FIG. 2 shows i-t curves of the electrochemical sensor at a fixed methanol concentration, in which the 0.0V applied voltage is for a passive operation mode while 0.2V is for the active mode. The two curves shown here are obtained at 20° C. using 1.0 M methanol solution. It can be seen that the methanol oxidation current at the start of the measurement is much larger than that after a period of time. This indicates that the methanol sensor has a quick response in sensing the presence of methanol. The current decayed almost exponentially and required some time (20-50 sec) to reach steady state for both active and passive operation modes. These values are comparable to those given by previous reports. Clearly, the active mode with a small applied depolarization voltage gave rise to a much larger current signal.

### Example 2

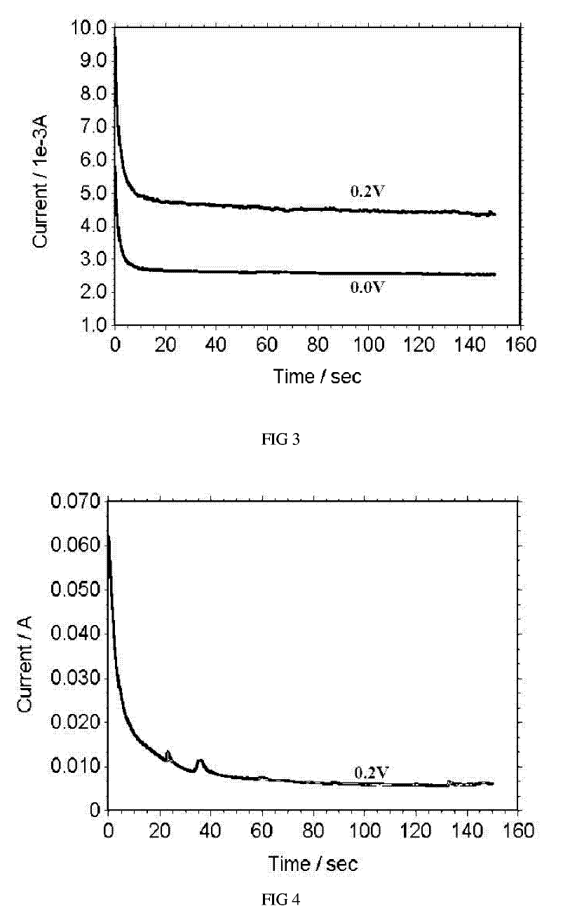

This embodiment serves to illustrate the capability of the electrochemical sensor in sensing concentration of an organic fuel solution other than methanol solution, such as formic acid solution. Formic acid has advantages of high safety and low crossover rate. It can be used as an alternative fuel for methanol. FIG. 3 shows i-t curves of the electrochemical sensor at a high concentration (6M) of formic acid solution, in which the 0.0V applied voltage is for a passive operation mode while 0.2V is for the active mode. The two curves shown here are obtained at 20° C. Clearly, the electrochemical sensor is not limited to be used with methanol fuel, but can also be applied to sensing a variety of organic fuel solutions.

### Example 3

This embodiment serves to illustrate the capability of the electrochemical sensor in sensing concentration of an inorganic fuel solution. Sodium borohydride has advantages of high hydrogen content and high electrochemical reaction rate. It can also be used as a fuel for membrane fuel cells. FIG. 4 shows an i-t curve of the electrochemical sensor working with 0.5 M NaBH₄ aqueous solution under an active mode. The curve shown here is obtained at 20° C. It can be seen that the electrochemical sensor can also be applied to sensing a variety of inorganic fuel solutions, in addition to organic fuel solutions.

### Example 4

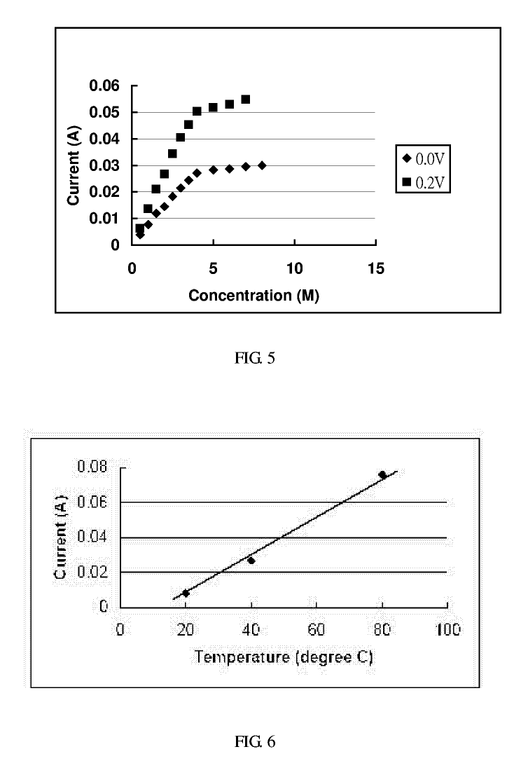

This embodiment exemplifies the relationship between the sensor output signal and the fuel concentration through the use of a calibration curve, i.e., a plot of fuel electro oxidation current vs. fuel concentration. FIG. 5 shows two typical calibration curves for the new electrochemical sensor, one for operation using a passive mode (0.0V) and the other using an active mode (0.2V). These calibration curves are constructed by taking the steady state (at 100 sec) current signal for various methanol concentrations at 40° C. It can be seen that a linear calibration curve is obtained up to 4 M CH₃OH. This relationship can be expressed as: i₁=m₁[c], where m₁ is the slope of the line and [c] is the methanol concentration in molar. As the methanol concentration increases, the calibration becomes flatter and difficult to distinguish the concentration from the reaction current signal. It indicates that the supply of air by natural diffusion and convention is enough up to 4 M at 40° C. as expected. In fact, judging from current portable DMFC operation conditions, this is a fairly good concentration range for a methanol sensor. To be able to operate within a wider concentration range is an additional advantage using a stagnant methanol solution, because the diffusion of methanol is relatively slow under such circumstances.

### Example 5

This embodiment explores the correlation among current, temperature and methanol concentration in designing a practical electrochemical sensor. In general, there exists a linear calibration curve for the electrochemical sensor when the operation temperature is varied between 20 and 80° C. FIG. 6 shows a linear i-T relationship at a fixed methanol concentration (2M). This linear relationship can be roughly expressed as: i₂=m₂T−a′, where m₂ is the slope of the line and a′ is the intercept. Thus, the overall correlation among current, temperature and methanol concentration can be expressed in a generalized form as: i=(mT−b)[c], where m and b are constants to be determined, T is the temperature in degree C. and [c] is the fuel concentration in molar.

Various additional modifications of the embodiments specifically illustrated and described herein will be apparent to those skilled in the art, particularly in light of the teachings of this invention. The invention should not be construed as limited to the specific form and examples as shown and described, but instead is set forth in the following claims.

What is claimed is:

1. An electrochemical sensor for sensing the concentration of a fuel prepared in an aqueous solution comprising a membrane electrode assembly including an anode and a cathode, two current collectors, an anode end plate and a cathode end plate in a compact form, characterized in that the cathode has an electrode area much larger than that of the anode, and each current collector has a drilled-through hole of different sizes for introduction of oxidant and fuel to the cathode and the anode, respectively, wherein the cathode end plate has a large hole exposing the cathode to ambient air while the anode end plate had a small reservoir coupled with two openings for addition and removal or flowing of fuel solution, and the sensor can be operated in a passive mode without applying an external DC voltage or in an active mode with application of a small external DC voltage within a wide range of temperature.

2. The electrochemical sensor of claim 1, wherein the sensor is for uses in direct methanol fuel cell (DMFC) systems.

3. The electrochemical sensor of claim 1, wherein the sensor is for uses in fuel cell systems using fuels prepared in aqueous solutions and the fuels include but are not limited to organic fuels, such as methanol, ethanol, formic acid, etc., and inorganic fuels, such as sodium and potassium borohydrides.

4. The electrochemical sensor of claim 1, wherein the sensor is for uses in fuel cell systems using, but is not limited to, ambient air as the oxidant.

5. The electrochemical sensor of claim 1, wherein the sensor has a membrane electrode assembly formed by hot pressing an electro catalytic anode and an electro catalytic cathode at each side of a proton exchange membrane, such as Nafion® 117, respectively and both anode and cathode are made of highly conductive materials, preferably carbon cloth or carbon paper, further, the anode uses Pt—Ru/C as an electro catalyst while the cathode uses Pt/C having high catalyst loadings at 2-20 mg/cm², preferably 4-10 mg/cm².

6. The electrochemical sensor of claim 5, wherein the electrode area of the cathode is much larger than that of the anode in the range of 2-100 times, preferably 4-10 times.

7. The electrochemical sensor of claim 1, wherein the sensor has two current collectors, one for anode and one for cathode, preferably made of thin graphite plates, and each current collector plate has a hole drilled through at the center exposing ambient air to the cathode and aqueous fuel solution to the anode, respectively.

8. The electrochemical sensor of claim 1, wherein the sensor drilled-through hole of the cathode current collector is much large than that of the anode in the range of 2-100 times, preferably 4-10 times.

9. The electrochemical sensor of claim 1, wherein the sensor is operated in a passive mode without applying an external DC voltage or in an active mode with application of a small external DC voltage, preferably <0.3V.

10. The electrochemical sensor of claim 1, wherein the sensor is operated with fuel solution under a stagnant condition or in a flowing condition.

11. The electrochemical sensor of claim 1, wherein the sensor is operated between 0-100° C., preferably 20-80° C.
